(19) United States
(12) Patent Application Publication
(10) Pub. No.: US 2020/0201211 A1
(43) Pub. Date: Jun. 25, 2020

(54) IMAGE FORMING APPARATUS AND IMAGE FORMING SYSTEM

(71) Applicant: TOSHIBA TEC KABUSHIKI KAISHA, Tokyo (JP)

(72) Inventor: Yoshiki Kogiso, Numazu Shizuoka (JP)

(21) Appl. No.: 16/520,376

(22) Filed: Jul. 24, 2019

(30) Foreign Application Priority Data
Dec. 20, 2018 (JP) 2018-238218

(51) Int. Cl. G03G 15/16

(52) U.S. Cl. CPC G03G 15/1665

(57) ABSTRACT

According to one embodiment, an image forming apparatus includes a communication unit, a controller, and a transfer unit. The controller is configured to acquire developer information from a container of the developer attached to the own apparatus, to acquire transfer bias information corresponding to the developer information from a storage unit of the server through the communication unit among a plurality of transfer bias information in which sheet information is associated with a bias value relating to a bias used for transfer, to acquire the bias value corresponding to the acquired developer information and sheet information of a sheet used for forming an image from the transfer bias information, and to determine a transfer bias used in a transfer roller based on the acquired bias value. The transfer unit is configured to transfer the developer to the sheet by applying the transfer bias.

### CROSS-REFERENCE TO RELATED APPLICATIONS

This application is based upon and claims the benefit of priority from Japanese Patent Application No. 2018-238218, filed Dec. 20, 2018, the entire contents of which are incorporated herein by reference.

### FIELD

Embodiments described herein relate generally to an image forming apparatus and an image forming system.

### BACKGROUND

An image forming apparatus such as an MFP (Multi-Function Peripheral) includes a transfer unit that forms a visible image on a sheet by transferring a developer to the sheet. The transfer unit transfers the developer to the sheet by applying a transfer bias (voltage or current) corresponding to the type of the sheet to a transfer roller. In the image forming apparatus, correspondence information in which the type of the sheet and the transfer bias are associated with each other is preset. The image forming apparatus can determine the transfer bias corresponding to the type of the sheet based on the preset correspondence information.

However, when the developer is changed, the preset transfer bias is not suitable although the type of the sheet is still the same. Therefore, the developer may not be smoothly transferred.

### DESCRIPTION OF THE DRAWINGS

FIG. 1 is an overall configuration example illustrating an image forming system according to an embodiment;

FIG. 2 is a diagram illustrating an example of a secondary transfer bias table;

FIG. 3 is an appearance diagram illustrating an overall configuration example of an image forming apparatus;

FIG. 4 is a diagram illustrating a schematic configuration of a printer;

FIG. 5 is a diagram illustrating a specific example of a developer information table;

FIG. 6 is a diagram illustrating a specific example of a sheet cassette table;

FIG. 7 is a diagram illustrating a specific example of an input screen when a transfer bias table is acquired from a server;

FIG. 8 is a diagram illustrating a specific example of an input screen when an input of a change in sheet cassette setting is received from a user;

FIG. 9 is a flowchart illustrating a specific example of a flow of processes for acquiring a transfer bias table associated with a developer set;

FIG. 10 is a diagram illustrating an example of a primary transfer bias table according to a modification example; and

FIG. 11 is a diagram illustrating a modification example of the transfer bias table.

### DETAILED DESCRIPTION

Embodiments provide an image forming apparatus and an image forming system that can transfer a developer according to the type of the developer with higher accuracy.

In general, according to one embodiment, an image forming apparatus includes a communication unit, a controller, and a transfer unit. The communication unit is configured to communicate with a server connected to the communication unit through a network. The controller is configured to acquire developer information representing a type of a developer from a container of the developer attached to the own apparatus, to acquire transfer bias information corresponding to the developer information from a storage unit of the server through the communication unit among a plurality of transfer bias information in which sheet information representing a type of a sheet is associated with a bias value that is a value relating to a bias used for transfer, to acquire the bias value corresponding to the acquired developer information and sheet information of a sheet used for forming an image from the transfer bias information, and to determine a transfer bias used in a transfer roller based on the acquired bias value. The transfer unit is configured to transfer the developer to the sheet by applying the transfer bias determined by the controller.

Hereinafter, an image forming apparatus and an image forming system according to an embodiment will be described with reference to the drawings.

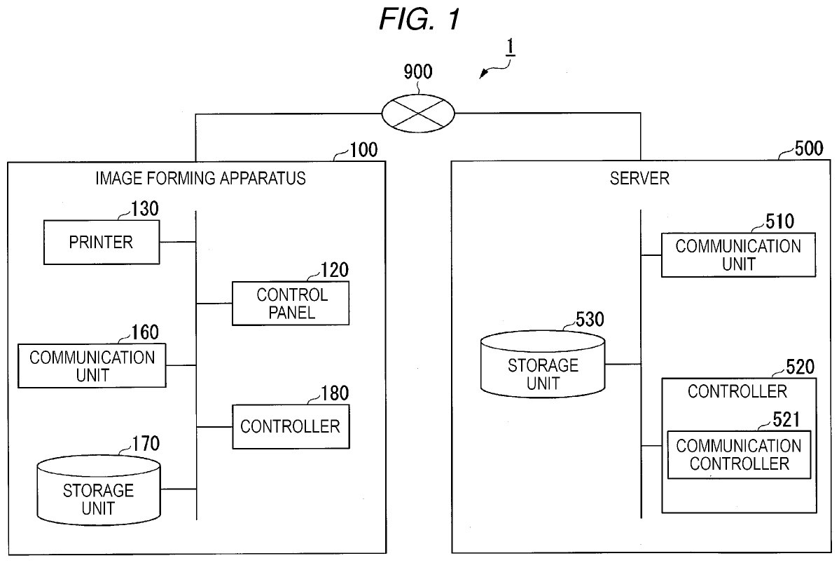

FIG. 1 is a diagram illustrating an overall configuration example illustrating an image forming system 1 according to the embodiment. The image forming system 1 includes an image forming apparatus 100 and a server 500. The image forming apparatus 100 and the server 500 are communicatively connected to each other through a network 900.

The network 900 is configured using a network such as a LAN (Local Area Network), a WAN (Wide Area Network), or the Internet. A method of connecting the image forming apparatus 100 and the server 500 to the network 900 may be wired or wireless.

The server 500 includes a communication unit 510, a controller 520, and a storage unit 530.

The communication unit 510 is a communication interface. The communication unit 510 communicates data with the image forming apparatus 100 through the network 900.

The controller 520 is configured using a processor such as a CPU (Central Processing Unit). By the processor executing a program, the controller 520 functions as a communication controller 521.

The communication controller 521 controls the communication unit 510. For example, the communication controller 521 transmits data to the image forming apparatus 100. For example, the communication controller 521 receives data from the image forming apparatus 100.

The storage unit 530 is configured using a storage device such as a magnetic hard disk device or a semiconductor memory device. The storage unit 530 stores a transfer bias table in which a transfer bias and sheet information are associated with each other in advance. The sheet information is information representing a type of a sheet. The type of a sheet is information relating to a sheet such as a manufacturer of a sheet, a product name of a sheet, or a kind of a sheet. The transfer bias table is a data table in which a transfer bias and sheet information that are determined depending on a type of a developer are stored in association with each other. The transfer bias is a voltage or current value that is applied to a transfer unit. The transfer bias is determined based on sheet information and a type of a developer. The storage unit 530 stores a plurality of transfer bias tables depending on a type of a developer. The transfer bias information is a transfer bias that is determined based on a type of a developer and sheet information. That is, the transfer bias table is one aspect of the transfer bias information.

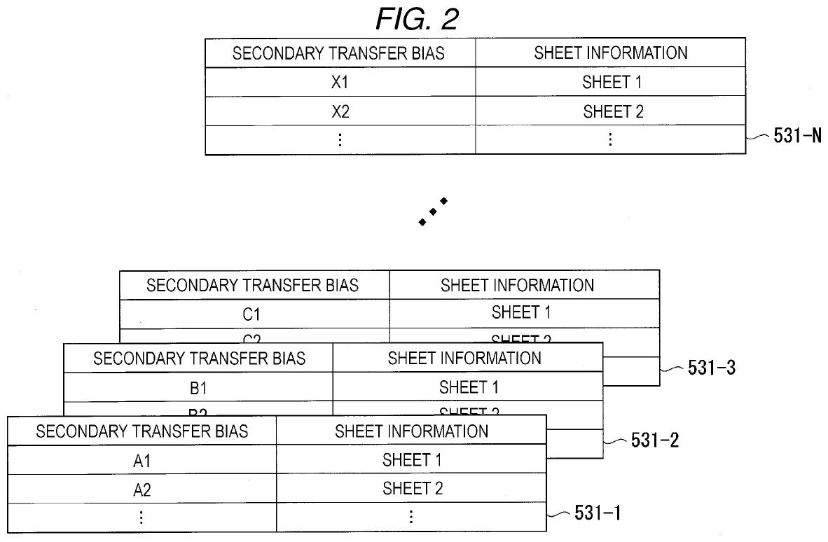

FIG. 2 is a diagram illustrating an example of a secondary transfer bias table 531 (one aspect of the transfer bias table) according to the embodiment. In the embodiment, the image forming apparatus 100 that executes secondary transfer will be described. The secondary transfer bias table 531 is a specific example of the transfer bias table. The secondary transfer bias is a voltage or current value that is applied whenever secondary transfer is executed using a plurality of developers (hereinafter, referred to as “developer set”) or using a single developer (for example, decolorable toner). For example, the developer set is a set of developers of Y (yellow), M (magenta), C (cyan), K (black), and the like. In the secondary transfer bias table 531 illustrated in FIG. 2, a secondary transfer bias that is determined based on sheet information and a type of a developer is stored in association with the sheet information. When transfer is executed using different developer sets and the same type of sheets, transfer biases are different. Therefore, it is necessary to look up a table of a developer set among a plurality of transfer bias tables. Thus, the storage unit 530 stores a plurality of transfer bias tables that are set for each developer set. The storage unit 530 stores secondary transfer bias tables 531-1 to 531-N (N represents an integer of 2 or more). When it is not necessary to distinguish among the secondary transfer bias tables 531-1 to 531-N, the secondary transfer bias tables 531-1 to 531-N will be simply referred to as “secondary transfer bias table 531”.

The description will be made using a specific example. In an example illustrated in FIG. 2, columns in the secondary transfer bias table 531 are “Secondary Transfer Bias” and “Sheet Information”. In a record in the top section of the secondary transfer bias table 531-1, “Secondary Transfer Bias” is “A1”. In the record in the top section of the secondary transfer bias table 531-1, “Sheet Information” is “Sheet 1”. The secondary transfer bias table 531 includes information corresponding to the columns for each developer set.

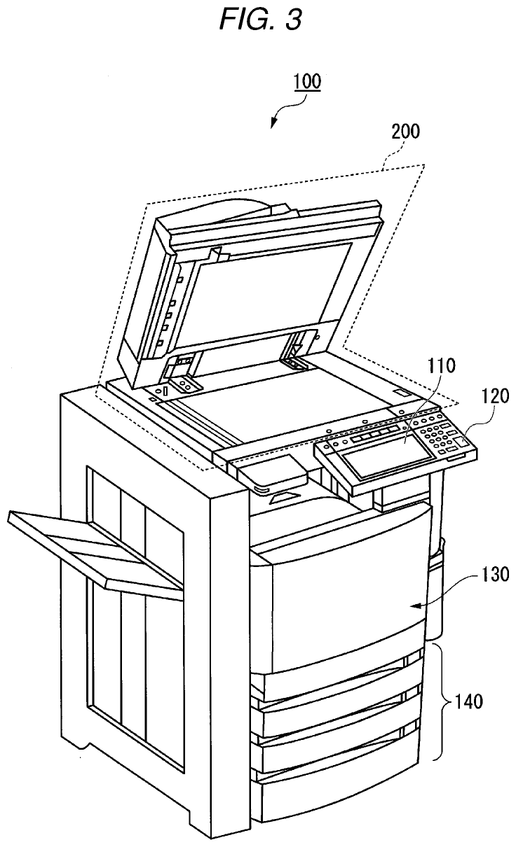

FIG. 3 is an appearance diagram illustrating an overall configuration example of the image forming apparatus 100 according to the embodiment.

The image forming apparatus 100 is, for example, a multi-function peripheral. The image forming apparatus 100 includes a display 110, a control panel 120, a printer 130, a sheet accommodation unit 140, and an image reading unit 200.

The image forming apparatus 100 forms an image on a sheet using a developer such as toner. The sheet is, for example, paper or label paper. The sheet may be any material as long as the image forming apparatus 100 can form an image on a surface of the sheet.

The display 110 is an image display device such as a liquid crystal display or an organic EL (Electro Luminescence) display. The display 110 displays various types of information relating to the image forming apparatus 100.

The control panel 120 includes a plurality of buttons. The control panel 120 receives the operation of a user. The control panel 120 outputs a signal corresponding to the operation input by the user to a controller 180 of the image forming apparatus 100. In addition, the display 110 and the control panel 120 may be configured to be integrated into a touch panel.

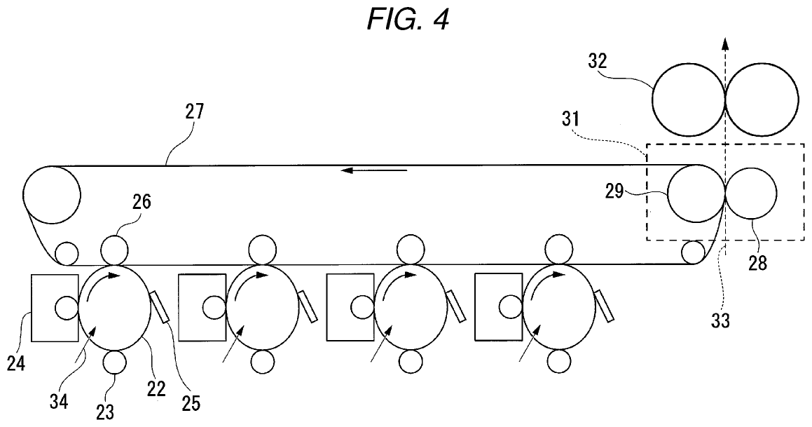

The printer 130 forms an image on the sheet based on image information generated by the image reading unit 200 or image information received through a communication path. FIG. 4 is a diagram illustrating a schematic configuration of the printer 130. The printer 130 includes, for example, a photoreceptor 22, a charging unit 23, a developing unit 24, a photoreceptor cleaner 25, a primary transfer roller 26, an intermediate transfer belt 27, a secondary transfer roller 28, a facing roller 29, and a fixing unit 32. The secondary transfer roller 28 and the facing roller 29 form a secondary transfer unit 31. A sheet 33 passes through the secondary transfer unit 31 and the fixing unit 32. The printer 130 forms an image through, for example, the following process. A surface of a drum of the photoreceptor 22 is charged by passing through the vicinity of the charging unit 23. The printer 130 irradiates the drum of the photoreceptor 22 with laser light 34 based on image information to form an electrostatic latent image. The developing unit 24 applies the developer to the electrostatic latent image to form a visible image on the photoreceptor 22. Specific examples of the developer include toner. The primary transfer roller 26 transfers the visible image to the intermediate transfer belt 27. By executing the above-described processes using one toner or a plurality of toners for forming the image, the image is formed on the transfer belt 27. In the secondary transfer unit 31, the secondary transfer roller 28 and the facing roller 29 transfers the visible image on the intermediate transfer belt 27 to the sheet 33. The secondary transfer unit 31 of the printer 130 is one specific example of a sheet transfer unit. The sheet transfer unit is configured to transfer the visible image formed using the developer to a surface of the sheet. When only one developer is used, the sheet transfer unit may be configured as a primary transfer unit. In this case, the primary transfer unit may be configured to include the primary transfer roller and the facing roller.

The sheet transfer unit transfers the developer to the sheet by applying a voltage or a current of a transfer bias corresponding to the type of the developer and the sheet information in the transfer bias table. A target to which the transfer bias is applied may be any of a plurality of rollers constituting the sheet transfer unit. For example, when the sheet transfer unit includes the secondary transfer roller 28 and the facing roller 29, the secondary transfer roller may beset as GND and the transfer bias may be applied to the facing roller 29. For example, when the sheet transfer unit includes the secondary transfer roller 28 and the facing roller 29, the facing roller 29 may be set as GND and the transfer bias may be applied to the secondary transfer roller 28. In the following description, the rollers (for example, the secondary transfer roller 28 and the facing roller 29) in the sheet transfer unit will be collectively referred to as “transfer roller”. The transfer roller also includes the primary transfer roller and the facing roller. The sheet information and the transfer bias table will be described below. The fixing unit 32 of the printer 130 applies heat and pressure to the sheet to fix the visible image to the sheet. Although not illustrated in the drawing, the same operation can be executed even on a sheet that is manually fed. Therefore, the sheet on which the image is formed may be a sheet accommodated in the sheet accommodation unit 140 or a sheet that is manually fed.

The sheet accommodation unit 140 accommodates the sheet used for forming the image in the printer 130.

The image reading unit 200 reads image information of a reading target in the form of brightness of light. The image reading unit 200 records the read image information. The recorded image information may be transmitted to another information processing apparatus through a network. Based on the recorded image information, the printer 130 may form an image on the sheet.

The image forming apparatus 100 includes the control panel 120, the printer 130, a communication unit 160, a storage unit 170, and the controller 180. The description of the control panel 120 and the printer 130 described above using FIG. 3 will not be repeated.

The communication unit 160 is a communication interface. The communication unit 160 communicates data with the server 500 through the network 900.

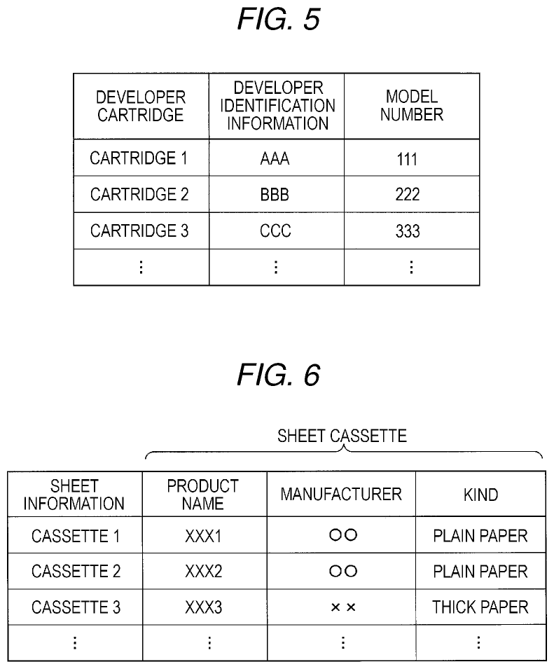

The storage unit 170 is configured using a storage device such as a magnetic hard disk device or a semiconductor memory device. The storage unit 170 includes the sheet information, a data table for authenticating the developer (hereinafter, referred to as “developer information table”), the transfer bias table, and a sheet cassette table. The sheet cassette table is a data table in which sheet information that is set by the user and a sheet cassette that accommodates a sheet are associated with each other. The developer information table will be described using FIG. 5. The sheet cassette table will be described using FIG. 6.

FIG. 5 is a diagram illustrating a specific example of the developer information table according to the embodiment.

The developer information table includes developer identification information for identifying at least one of the developer or a developer cartridge (container). The developer information includes the type of the developer and information for identifying the developer (hereinafter, referred to as “developer identification information”). The type of the developer is information relating to the developer such as a manufacturer name of the developer, the color of the developer, a model number of the developer, or whether or not the developer is decolorable. For example, the developer identification information is a character string such as an encryption key or a password.

The description will be made using a specific example. In an example illustrated in FIG. 5, columns in the developer information table are “Developer Cartridge”, “Developer Identification Information” and “Model Number”. “Developer Identification Information” of a developer cartridge 1 is “AAA”. “Model Number” of the developer cartridge 1 is “111”. The developer information table includes information corresponding to the columns for each developer cartridge.

The developer information table illustrated in FIG. 5 is merely one specific example. Therefore, the developer information table may be configured in an aspect different from that of FIG. 5. For example, the developer information table may include a column of a model number of an image forming apparatus to be used.

FIG. 6 is a diagram illustrating a specific example of the sheet cassette table according to the embodiment.

The storage unit 170 stores, for example, the sheet cassette table illustrated in FIG. 6. The sheet cassette table is generated based on information representing a manufacturer of a sheet, a product name of a sheet, and a kind of a sheet. The manufacturer is information representing a name of a manufacturer of a sheet. The product name is information representing a product name of a sheet. The kind is information representing a kind of a sheet such as plain paper or thick paper.

The description will be made using a specific example. In an example illustrated in FIG. 6, columns in the sheet cassette table are “Sheet Cassette”, “Product Name”, “Manufacturer”, and “Kind”. “Product Name” of a sheet cassette 1 is “XXX1”. “Manufacturer” of the sheet cassette 1 is “OO”. “Kind” of the sheet cassette 1 is “Plain Paper”. The sheet cassette table includes information corresponding to the columns for each sheet cassette.

The sheet cassette table illustrated in FIG. 6 is merely one specific example. Therefore, the sheet cassette table may be configured in an aspect different from that of FIG. 6. For example, the sheet cassette table may include a column of a size of a sheet to be accommodated.

The controller 180 is configured using a processor such as a CPU. By the processor executing a program, the controller 180 operates.

The controller 180 acquires the developer information from a recording medium that is included in the developer cartridge attached to the own apparatus. The recording medium is a medium such as an IC (Integrated Circuit) chip or an RFID (Radio Frequency Identifier) that is included in the developer cartridge and can record the developer information.

The controller 180 determines whether or not the developer cartridge is genuine based on the developer identification information and the developer information table that is stored in the storage unit 170. The controller 180 compares the developer identification information and the developer information table to each other to determine whether or not the developer cartridge is genuine. That is, the controller 180 searches for the developer identification information using the identification information of the developer information table. When the developer identification information is present in the identification information of the developer information table, the controller 180 determines that the developer cartridge is genuine. When the developer identification information is not present in the identification information of the developer information table, the controller 180 determines that the developer cartridge is not genuine.

The controller 180 acquires the sheet information of a sheet accommodated in a sheet cassette. The controller 180 acquires the sheet information set for the image forming apparatus 100 from the storage unit 170.

The controller 180 acquires a plurality of sheet information candidates from the server 500 through the communication unit 160 and causes a display unit to display the sheet information candidates. For example, the controller 180 displays manufacturer names of sheets and product names of sheets in the sheet information. When the transfer bias table is acquired from the server 500 and when an input of a change in sheet cassette setting is received from the user, the controller 180 causes the display unit to display the sheet information.

When the transfer bias table is acquired from the server 500, the controller 180 causes the display unit to display a manufacturer name of a sheet and a product name of a sheet and receives an input from the user. As a result, the controller 180 does not need to acquire all the transfer bias tables from the server 500 and can acquire only a transfer bias table based on the sheet information selected by the user and the type of the developer.

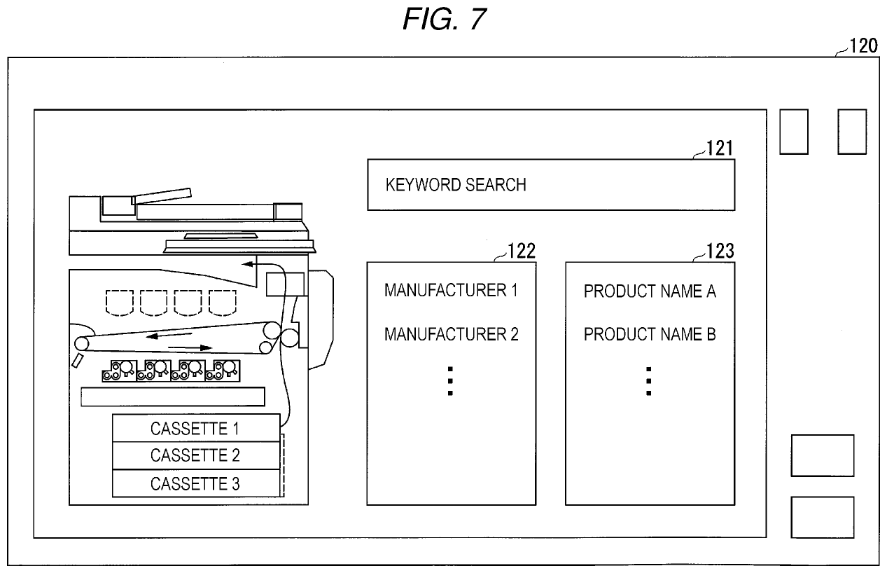

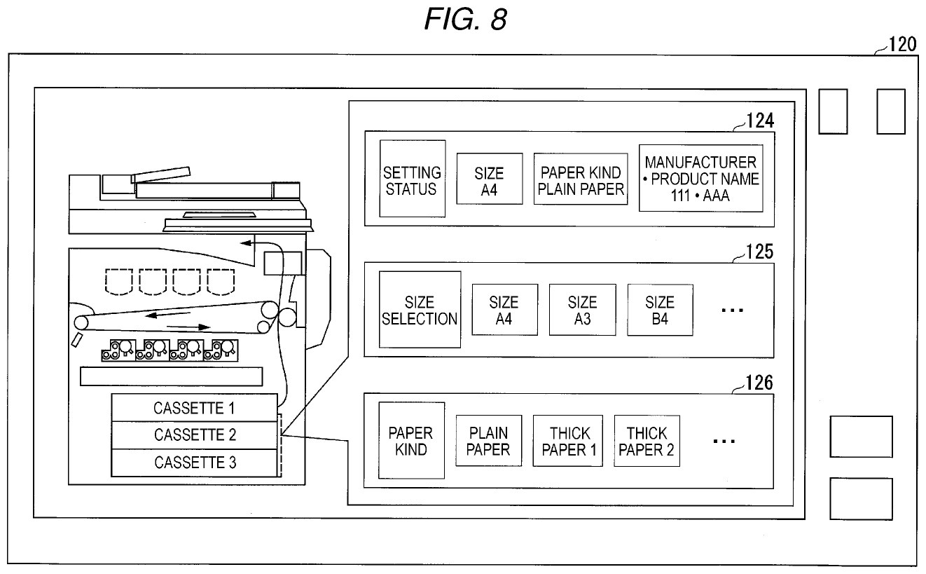

When an input of a change in sheet cassette setting is received from the user, the controller 180 causes the display unit to display a manufacturer name of a sheet and a product name of a sheet corresponding to the sheet cassette. As a result, the controller 180 can determine a transfer bias based on the sheet information selected from the transfer bias table. The controller 180 causes the control panel 120 to display information including either or both of a manufacturer of a sheet and a product name of a sheet as the sheet information candidate. Display examples in which the controller 180 causes the display unit to display the information will be described using FIGS. 7 and 8.

FIG. 7 is a diagram illustrating a specific example of an input screen when the transfer bias table is acquired from the server 500 according to the embodiment. For example, in FIG. 7, the display unit is the control panel 120. The control panel 120 displays an input field 121, a manufacturer selection field, 122, and a product name selection field 123. The control panel 120 receives an input of an instruction of sheet information selected by the user among the sheet information candidates.

The input field 121 is a screen region in which an input of a keyword is received from the user. In FIG. 7, the input field 121 is a region in which a keyword search can be executed, for example, by receiving a character string. The input field 121 receives an input of a character string such as a manufacturer name or a product name of a sheet from the user as a keyword.

The manufacturer selection field 122 is a screen region in which a manufacturer name of a sheet is selected. The controller 180 extracts information of “Manufacturer Name” from a plurality of sheet information acquired from the server 500 through the communication unit 160 and displays the extracted information in the manufacturer selection field 122. The manufacturer selection field 122 receives an input by the user pressing a manufacturer name of a sheet. For example, when the user presses “Manufacturer 1”, the controller 180 acquires a transfer bias table in which “Manufacturer” of the sheet information is “Manufacturer 1”.

The product name selection field 123 is a screen region in which a product name of a sheet is selected. The controller 180 extracts information of “Product Name” from a plurality of sheet information acquired from the server 500 through the communication unit 160 and displays the extracted information in the product name selection field 123. The product name selection field 123 receives an input by the user pressing a product name of a sheet. For example, when the user presses “Product Name A”, the controller 180 acquires a transfer bias table in which “Product Name” of the sheet information is “Product Name A”.

FIG. 8 is a diagram illustrating a specific example of an input screen when an input of a change in sheet cassette setting is received from the user according to the embodiment. For example, in FIG. 8, the display unit is the control panel 120. The control panel 120 includes a setting status check field 124, a size selection field 125, and a paper kind selection field 126. The control panel 120 receives an input of an instruction of sheet information selected by the user among the sheet information candidates.

The setting status check field 124 is a screen region in which a setting status set for a cassette 2 of the image forming apparatus 100 is displayed. The setting status refers to the details of the sheet information that is currently set for the image forming apparatus 100. For example, in FIG. 8, “Size”, “Paper Kind”, and “Manufacturer/Product Name” of the sheet information are displayed as the setting status. The setting status displayed in the setting status check field 124 is updated by receiving an input from the user in the size selection field 125 and the paper kind selection field 126.

The size selection field 125 is a screen region in which a size of a sheet is selected. The controller 180 extracts information of “Size” from a plurality of sheet information acquired from the server 500 through the communication unit 160 and displays the extracted information in the size selection field 125. The size selection field 125 receives an input by the user pressing a size of a sheet. For example, when the user presses “Size A4”, the controller 180 acquires “Size A4 (210 (mm)×297 (mm) as “Size” of the sheet information.

The paper kind selection field 126 is a screen region in which a paper kind of a sheet is selected. The controller 180 extracts information of “Paper Kind” from a plurality of sheet information acquired from the server 500 through the communication unit 160 and displays the extracted information in the paper kind selection field 126. The paper kind selection field 126 receives an input by the user pressing a paper kind of a sheet. For example, when the user presses “Plain Paper”, the controller 180 acquires “Plain Paper” as “Kind” of the sheet information.

When the developer or the developer cartridge is genuine, the controller 180 acquires a transfer bias table corresponding to the type of the developer among a plurality of transfer bias information stored in the storage unit 530 of the server 500 through the communication unit 160. The controller 180 acquires a transfer bias table from the server 500, the transfer bias table being associated with the sheet information selected by the user through the control panel 120. The controller 180 updates the transfer bias table stored in the storage unit 170 using the acquired transfer bias table.

The controller 180 determines a transfer bias used in the transfer unit during transfer from the transfer bias table stored in the storage unit 170 based on the sheet information and the transfer bias table. The controller 180 searches for the sheet information in the transfer bias table and determines a transfer bias associated with the corresponding sheet information as the transfer bias used in the transfer unit during transfer.

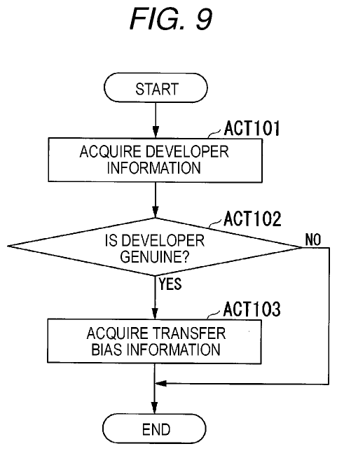

FIG. 9 is a flowchart illustrating a specific example of a flow of processes for acquiring the transfer bias table associated with the developer set according to the embodiment. The flowchart of FIG. 9 starts when the transfer bias table is acquired from the server 500.

The controller 180 acquires the developer information from the recording medium of the developer cartridge connected to the printer 130 (ACT 101). The controller 180 determines whether or not the developer cartridge is genuine based on the developer identification information and the developer information table that is stored in the storage unit 170 (ACT 102).

When the identification information in the developer information is not present in the identification information of the developer information table (ACT 102: NO), the controller 180 determines that the developer cartridge is not genuine. Next, the image forming apparatus 100 ends the process. When the identification information in the developer information is present in the identification information of the developer information table (ACT 102: YES), the controller 180 determines that the developer cartridge is genuine. The controller 180 acquires a transfer bias table associated with the developer set from the server 500 through the network 900 (ACT 103).

The image forming system 1 having the above-described configuration includes the controller 180. As a result, a transfer bias corresponding to a type of a developer and a kind of a sheet can be determined. First, the controller 180 acquires the developer information from a recording medium that is included in the developer cartridge attached to the own apparatus. Next, the controller 180 acquires the sheet information. The controller 180 acquires a transfer bias table associated with the type of the developer from the server 500. The controller 180 updates the transfer bias table stored in the storage unit 170 using the acquired transfer bias table. The controller 180 searches for the sheet information in the transfer bias table and determines a transfer bias associated with the corresponding sheet information as the transfer bias applied during transfer. As a result, the image forming apparatus 100 can provide an image forming apparatus and an image forming system that can transfer a developer according to the type of the developer with higher accuracy.

### Modification Example

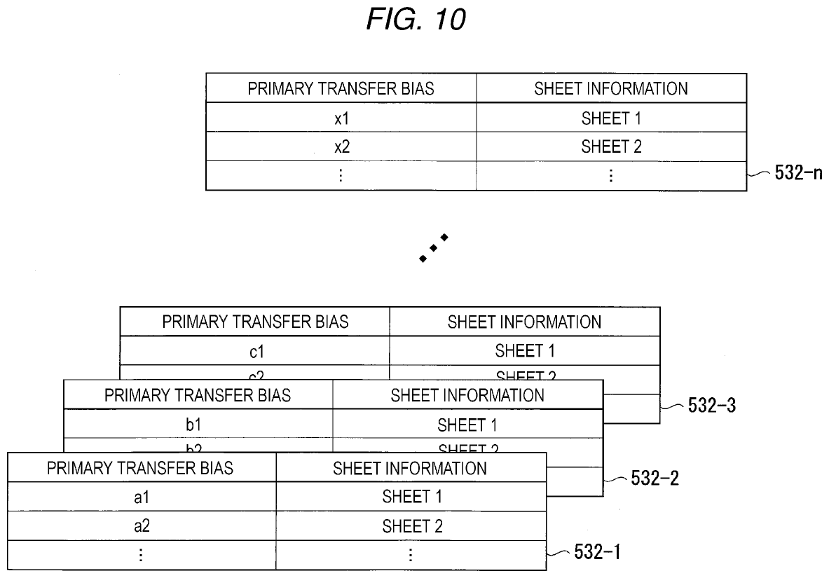

FIG. 10 is a diagram illustrating an example of a primary transfer bias table 532 according to a modification example. In the embodiment, the image forming apparatus 100 that executes primary transfer will be described. A primary transfer bias is a voltage or current value set for each developer. For example, the developer may be any one of developers of Y (yellow), M (magenta), C (cyan), K (black), and the like. In the primary transfer bias table 532 illustrated in FIG. 10, sheet information and a primary transfer bias corresponding to the sheet information are stored in association with each other. When transfer is executed using different developers and the same type of sheets, transfer biases are different. Therefore, it is necessary to lookup a table of a developer set among a plurality of transfer bias tables. The storage unit 530 stores a plurality of transfer bias tables classified for each developer. The storage unit 530 stores primary transfer bias tables 532-1 to 532-N (N represents an integer of 2 or more). When it is not necessary to distinguish among the primary transfer bias tables 532-1 to 532-N, the secondary transfer bias tables 532-1 to 532-N will be simply referred to as “secondary transfer bias table 532”.

The description will be made using a specific example. In an example illustrated in FIG. 10, columns in the primary transfer bias table 532 are “Primary Transfer Bias” and “Sheet Information”. In a record in the top section of the primary transfer bias table 532-1, “Primary Transfer Bias” is “a1”. In the record in the top section of the primary transfer bias table 532-1, “Sheet Information” is “Sheet 1”. The primary transfer bias table 532 includes information corresponding to the columns for each developer set.

The identification information of the developer information may be information for identifying a developer cartridge or information representing a developer.

The secondary transfer bias table 531 may be updated through the network 900 as the number of developers or the types of sheets increases.

The storage unit 170 may store a transfer bias table before the controller 180 updates the transfer bias table.

The storage unit 530 stores a first transfer bias table in which a first bias and sheet information are associated with each other in advance. The first bias is a bias value determined depending on a type of a sheet. The first transfer bias table is a data table in which a first bias and sheet information that are determined depending on a type of a developer are stored in association with each other.

In this case, a value of the transfer bias may be calculated based on a value of the first bias and a value of a second bias. The second bias is a value obtained based on the sum of resistance values of members having a large direct or indirect contact area with the transfer roller in a state where paper is not fed. For example, the second bias is the sum of resistance values between the transfer roller, the transfer belt, and the facing roller. The second bias may be determined based on a resistance value calculated based on a voltage value that is measured, for example, when a predetermined current is applied to the transfer roller in a state where paper is not fed. The controller 520 may determine a value of the transfer bias by adding the obtained value of the first bias and the obtained value of the second bias.

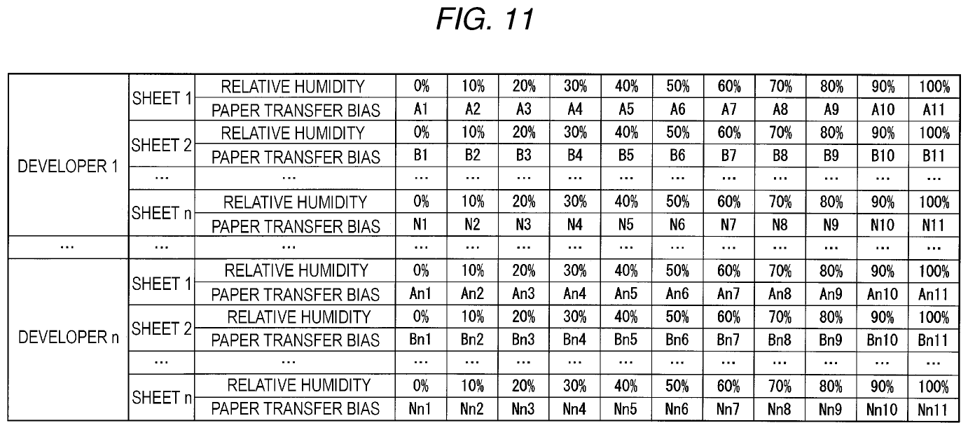

FIG. 11 is a diagram illustrating a modification example of the transfer bias table. The transfer bias table may be configured to determine a transfer bias based on another type of information in addition to sheet information and a type of a developer. In an example of FIG. 11, the transfer bias table is configured such that a transfer bias is determined based on a partition of values of relative humidity in addition to sheet information (sheet, 1, sheet 2, . . . , and sheet n) and a type of a developer (developer 1, . . . , and developer n). In this case, the controller 180 acquires a value of the transfer bias associated with sheet information, a type of a developer, and a partition of relative humidity from the transfer bias table.

At least a part of the functions of the image forming apparatus 100 in the embodiment may be implemented by a computer. In this case, a program for implementing this function may be recorded in a computer-readable recording medium. In addition, the function may be implemented by causing a computer system to read the program recorded in the recording medium and to execute the read program. The definition of “computer system” described herein includes an OS and hardware such as a peripheral. In addition, “computer-readable recording medium” refers to a storage device such as a hard disk built into a computer system. The storage device includes a portable medium such as a flexible disk, a magneto-optic disk, a ROM, a CD-ROM, a DVD-ROM or an USB memory. Further, “computer-readable recording medium” may dynamically store a program for a short period of time. Specifically, “computer-readable recording medium” may be a communication line when a program is transmitted through a network such as the Internet or a communication line such as a telephone line. In addition, “computer-readable recording medium” may be a medium that stores a program for a certain period of time. Specifically, “computer-readable recording medium” may be a volatile memory in a computer system that functions as a server or a client. In addition, the program may implement some of the above-described functions. Further, the program may implement the above-described function in combination with a program that is recorded in advance in a computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a communication unit configured to communicate with a server connected to the image forming apparatus through a network;
a controller configured to acquire developer information representing a type of a developer from a container of the developer attached to the image forming apparatus, to acquire transfer bias information corresponding to the developer information from a storage unit of the server through the communication unit among a plurality of transfer bias information in which sheet information representing a type of a sheet is associated with a bias value relating to a bias used for transfer, to acquire the bias value corresponding to the acquired developer information and sheet information of a sheet used for forming an image from the transfer bias information, and to determine a transfer bias used in a transfer roller based on the acquired bias value; and
a transfer unit configured to transfer the developer to the sheet by applying the transfer bias determined by the controller.

2. The apparatus according to claim 1, wherein
the developer information includes identification information for identifying at least one of the developer and the container, and
the controller determines whether or not the developer or the container is genuine based on the identification information and, when the developer or the container is genuine, acquires the transfer bias information from the server.

3. The apparatus according to claim 1, wherein
the controller determines whether or not the developer or the container is counterfeit based on the identification information.

4. The apparatus according to claim 1, wherein
the controller acquires a plurality of sheet information candidates from the server through the communication unit and causes a display unit to display the sheet information candidates,
the apparatus further comprises an input unit configured to receive an input of an instruction of sheet information selected by a user among the sheet information candidates, and
the controller acquires transfer bias information from the server, the transfer bias information being associated with the sheet information selected by the user through the input unit.

5. The apparatus according to claim 4, wherein
the sheet information candidates include at least one of a manufacturer of a sheet and a product name of a sheet.

6. The apparatus according to claim 1, wherein
the developer information comprises whether or not the developer is a decolorable developer.

7. The apparatus according to claim 1, wherein
the communication unit communicates with the server through a wireless network.

8. An image forming system, comprising:
a server including a storage unit configured to store transfer bias information in which sheet information representing a type of a sheet is associated with a transfer bias that is a voltage value or a current value for each developer information representing a type of a developer; and
an image forming apparatus comprising:
a communication unit configured to communicate with a server connected to the image forming apparatus through a network;
a controller configured to acquire developer information representing a type of a developer from a container of the developer attached to the image forming apparatus, to acquire transfer bias information corresponding to the developer information from a storage unit of the server through the communication unit among a plurality of transfer bias information in which sheet information representing a type of a sheet is associated with a bias value relating to a bias used for transfer, to acquire the bias value corresponding to the acquired developer information and sheet information of a sheet used for forming an image from the transfer bias information, and to determine a transfer bias used in a transfer roller based on the acquired bias value; and
a transfer unit configured to transfer the developer to the sheet by applying the transfer bias determined by the controller.

9. The image forming system according to claim 8, wherein
the developer information includes identification information for identifying at least one of the developer and the container, and
the controller determines whether or not the developer or the container is genuine based on the identification information and, when the developer or the container is genuine, acquires the transfer bias information from the server.

10. The image forming system according to claim 8, wherein
the controller determines whether or not the developer or the container is counterfeit based on the identification information.

11. The image forming system according to claim 8, wherein
the controller acquires a plurality of sheet information candidates from the server through the communication unit and causes a display unit to display the sheet information candidates,
the apparatus further comprises an input unit configured to receive an input of an instruction of sheet information selected by a user among the sheet information candidates, and
the controller acquires transfer bias information from the server, the transfer bias information being associated with the sheet information selected by the user through the input unit.

12. The image forming system according to claim 11, wherein
the sheet information candidates include at least one of a manufacturer of a sheet and a product name of a sheet.

13. The image forming system according to claim 8, wherein
the developer information comprises whether or not the developer is a decolorable developer.

14. The image forming system according to claim 8, wherein
the communication unit communicates with the server through a wired network.

15. A method for an image forming apparatus, comprising:
acquiring developer information representing a type of a developer from a container of the developer attached to the image forming apparatus;
acquiring transfer bias information corresponding to the developer information from a storage unit of a server through a communication unit of the image forming apparatus among a plurality of transfer bias information in which sheet information representing a type of a sheet is associated with a bias value relating to a bias used for transfer;
acquiring the bias value corresponding to the acquired developer information and sheet information of a sheet used for forming an image from the transfer bias information;
determining a transfer bias for use in a transfer roller based on the acquired bias value; and
a transfer unit configured to transferring the developer to the sheet by applying the transfer bias determined.

16. The method according to claim 15, wherein
the developer information includes identification information for identifying at least one of the developer and the container, and further comprising:
determining whether or not the developer or the container is genuine based on the identification information and, when the developer or the container is genuine, acquiring the transfer bias information from the server.

17. The method according to claim 15, further comprising:
determining whether or not the developer or the container is counterfeit based on the identification information.

18. The method according to claim 15, further comprising:
acquiring a plurality of sheet information candidates from the server through the communication unit and causing a display unit to display the sheet information candidates,
receiving an input of an instruction of sheet information selected by a user among the sheet information candidates, and
acquiring transfer bias information from the server, the transfer bias information being associated with the sheet information selected by the user through the input unit.

19. The method according to claim 18, wherein
the sheet information candidates include at least one of a manufacturer of a sheet and a product name of a sheet.

20. The method according to claim 15, further comprising:
determining whether or not the developer is a decolorable developer.
